(19) United States
(12) Patent Application Publication
(10) Pub. No.: US 2026/0192595 A1
(43) Pub. Date: Jul. 9, 2026

(54) VENTING SYSTEM, HUBCAP AND USE OF A HUBCAP IN A COMMERCIAL VEHICLE

(71) Applicant: SAF-HOLLAND GmbH, Bessenbach (DE)

(72) Inventor: Muhammet Arpaci, Aschaffenburg (DE)

(21) Appl. No.: 18/866,735

(22) PCT Filed: Nov. 14, 2023
(86) PCT No.: PCT/EP2023/081679

§ 371 Date: Nov. 18, 2024

(30) Foreign Application Priority Data
Nov. 14, 2022 (DE) 10 2022 130 085.4

(51) Int. Cl. B60B 7/00; B60C 29/06

(52) U.S. Cl. CPC B60B 7/002; B60C 29/066; B60C 29/068; B60B 2900/133; B60C 2200/06

(57) ABSTRACT

A venting system includes a base body and a sealing ring or a plurality of sealing rings, wherein the base body extends in a longitudinal direction, wherein the base body has a mounting section and a sealing section, wherein the base body has a fluid channel which extends from the mounting section into the sealing section, wherein the sealing ring or the sealing rings is/are each held in a circumferential groove in the sealing section, wherein the groove or the grooves are or can be brought into fluid connection with the fluid channel, in particular via breakthroughs, wherein a sound-absorbing element is arranged inside the fluid channel.

### BACKGROUND

The invention relates to a venting system, a hubcap and the use of a hubcap in a commercial vehicle.

Compressed air systems are known in the prior art. In particular, tire inflation systems for commercial vehicles, which serve to ensure that the tire can be filled with compressed air-even while driving, for example. The problem with these systems, however, is that they have to be deflated in the event of overpressure, which often occurs in commercial vehicles. During venting, however, dirt and moisture can easily enter the compressed air system and, at the same time, considerable noise pollution can occur in the environment. Preventing these two negative effects is often achieved by a wide variety of means, so that a large installation space is required.

It is therefore the object of the invention to achieve a safe venting that can keep contaminants out of the compressed air system and at the same time only requires a small installation space and also reduces noise pollution in the environment.

### SUMMARY OF THE INVENTION

According to the invention is provided a venting system. Advantageously, the venting system comprises a base body and a sealing ring or a plurality of sealing rings, wherein the base body can have a mounting section and a sealing section, wherein the base body, the mounting section and/or the sealing section can extend in a longitudinal direction, wherein the base body has a fluid channel which extends from the mounting section into the sealing section, wherein the sealing ring or the sealing rings is/are each held in a circumferential groove in the sealing section, wherein the groove or the grooves are or can be brought into fluid connection with the fluid channel, in particular via breakthroughs, wherein a sound-absorbing element is or can be arranged within the fluid channel. The venting system serves to provide a fluid-active connection between a compressed air system and the environment. A fluid-effective connection or a fluid connection in the sense of the invention means in particular that a fluid can flow from one area into the other area, which are in fluid connection with each other. The venting system can in particular be part of a commercial vehicle and connect a compressed air system of the commercial vehicle, in particular a compressed air system of a tire inflation system of the commercial vehicle, to the environment in a fluid-connecting manner. The venting system can therefore in particular also be part of a tire inflation system of a vehicle, in particular a commercial vehicle. A commercial vehicle in the sense of the invention is in particular a vehicle with an additional total mass of more than 3.5 tons, preferably more than 7.5 tons and particularly preferably more than 15 tons. Alternatively or additionally preferably, the commercial vehicle can in particular be a road-going or road-bound commercial vehicle. The commercial vehicle is particularly preferably a commercial vehicle trailer, especially a semi-trailer. The venting system has a base body, wherein this base body can in particular be designed in one piece in order to achieve a particularly high mechanical strength. In particular, the base body is the main element of the venting system. The base body extends along a longitudinal direction. Alternatively, preferably, only the mounting section can extend in the longitudinal direction or the sealing section. However, it is preferable if both the sealing section and the mounting section extend in the longitudinal direction. This makes it easier to manufacture. The longitudinal direction is in particular the direction in which the base body, the mounting section, the sealing section and/or the venting system has/have its largest main dimension. Conveniently, the longitudinal direction extends through the center of gravity of the base body and/or forms a central axis of the base body or the mounting section. The base body itself has at least one mounting section and one sealing section. The mounting section of the base body is used to attach the base body to another element or component. Alternatively, preferably, the mounting section can also be a material-locking joining element and/or be formed in one piece with a further element, in particular a hub cap or center cap. In other words, the base body can therefore be connected to a further element or component via the mounting section. For example, the base body can therefore be formed in one piece with a hub cap or center cap. The invention can therefore in particular also relate to a center cap system or a hub cap system, wherein the center cap can in particular be formed integrally with the base body. Alternatively or additionally preferably, the mounting section can also fundamentally have reversible fastening means, in particular a thread. This thread can be designed as an internal thread or an external thread. The base body can be made of plastic or metal. The advantage of plastic is primarily its corrosion resistance and/or its low cost. The advantage of metal, in particular aluminum, brass or steel, lies primarily in its strength. In addition to the mounting section, the base body of the venting system also has a sealing section. This sealing section is used to provide the arrangement area for the sealing rings or the sealing ring. In order to secure the position of the sealing ring or sealing rings, a circumferential groove is provided in the sealing section for each sealing ring. Advantageously, this circumferential groove extends in a plane that is perpendicular to the longitudinal direction. In particular, the longitudinal direction is perpendicular to a radial direction, wherein the longitudinal direction, the radial direction and a circumferential direction can in particular form a cylindrical coordinate system with each other. The circumferential grooves are formed in the base body, in particular in a radial direction towards the longitudinal direction, therefore in particular from the outside of the base body. In addition, the base body also has a fluid channel which can connect the mounting section to the sealing section in terms of fluid technology. In particular, the fluid channel has a fluid outlet in the mounting section so that a fluid can flow into the mounting section via the fluid channel into the sealing section. The fluid channel is designed in particular around the longitudinal direction. The fluid channel is preferably rotationally symmetrical about the longitudinal direction. Alternatively, the fluid channel can also preferably be polygonal. This is particularly preferable if the base body is made of plastic. The angular design can be used in particular to secure the position of the sound-absorbing element in a form-fit manner, especially against rotation. Advantageously, the outer contour of the sound-absorbing element corresponds to the contour of the fluid channel. Alternatively or additionally preferably, the sound-absorbing element, in particular with its outer contour, and the fluid channel form a fit, in particular an interference fit, with one another. Expediently, the fluid channel has a distal end, in particular in the longitudinal direction, in the sealing section of the base body. In order to be able to provide a fluid flow from the fluid channel into the grooves, breakthroughs can be provided which can achieve a fluid connection between the fluid channel and the grooves. In principle, however, bores or other fluid connection means can also be provided, which can achieve a fluid connection between the fluid channel and the grooves. This fluid connection therefore makes it possible to displace the sealing rings or the sealing ring arranged in the grooves or the groove in the event of excess pressure in the fluid channel, so that a fluid can flow into the environment past the side of the sealing ring. Venting can therefore be achieved in this way, but at the same time the sealing rings prevent dirt and/or moisture from entering the venting system, especially if there is insufficient pressure to displace the sealing rings. In addition to the base body and the sealing rings, the venting system preferably also has a sound-absorbing element. This sound-absorbing element is arranged at least in sections, preferably completely, inside the fluid channel. This arrangement within the fluid channel can be used to reduce and/or prevent noise-generating pressure surges through the sound-absorbing element. Advantageously, the sound-absorbing element is fluid-permeable. In other words, a fluid flow can take place through the sound-absorbing element. For example, this can be achieved using an open-pored foam. By arranging the sound-absorbing element within the fluid channel of the base body of the venting system, a particularly compact and space-saving arrangement can be achieved. Furthermore, this can also prevent damage to the sound-absorbing element, so that the invention is able to provide compact and safe sound reduction in the venting of a compressed air system. In principle, however, the invention can also be designed without the sound-absorbing element. If no sound-absorbing element is present, a compact and/or particularly well-protected venting option can be provided in particular.

Advantageously, at least one groove or the grooves, in particular the majority or all of the grooves, have a rounded side wall or a rounded groove base. This allows a particularly low-notch design to be achieved. Alternatively or additionally preferably, one groove, preferably the majority of the grooves and particularly preferably all grooves, can be V-shaped. In other words, the side walls of the groove can run in a straight line and/or at an angle to each other. In particular, this can achieve a particularly good centering effect of the sealing rings or the sealing ring in the respective V-shaped groove. Alternatively or additionally preferably, the side wall and/or the groove base of a groove, preferably the majority of the grooves and particularly preferably all grooves, can also have an angular design. This enables particularly simple production. In particular, some of the grooves can have rounded side walls and/or a rounded groove base, while at the same time other grooves can be V-shaped and/or angular. In particular, by designing the groove differently, for example with some V-shaped grooves and some angular grooves and/or some rounded grooves, the groove can be adapted to a corresponding pressure level for venting. This means, for example, that the venting or the amount of fluid that can be vented can take place in stages depending on the pressure level present.

Expediently, the mounting section has a thread, in particular a self-sealing thread, wherein the thread can be arranged around and/or along the longitudinal direction. By providing a thread in the mounting section, which can also be referred to as a mounting thread, a particularly simple and effective reversible fixing of the base body to a further element can be achieved. This thread can be designed in particular as an external thread and/or as an internal thread. Conveniently, the thread forms a distal end in the longitudinal direction of the base body. This enables a particularly simple mounting option to be achieved. In order to effectively prevent fluid flow into the environment, the thread should be designed as a self-sealing thread. Advantageously, the thread can in particular surround the fluid channel and/or, especially in the case of an internal thread, form part of the fluid channel. Alternatively or further preferably, the thread can in particular be formed around the longitudinal direction. In other words, the central axis of the thread can therefore lie in the longitudinal direction.

Expediently, the sealing section has an outer cylindrical or more angular section, in which section the grooves are provided, in particular in the direction of a radial direction and/or in the longitudinal direction. The radial direction is preferably, as already described, perpendicular to the axial direction and is a direction which exists independently of further features and/or properties of the invention. In other words, the sealing section advantageously has an external appearance in the area in which the groove or all grooves are provided, which is cylindrical and/or polygonal, in particular hexagonal or octagonal. The outer angular appearance or the cylindrical shape is formed in particular in such a way that this appearance is located in a cross-section which is formed by a sectional plane whose normal is parallel to the longitudinal direction. The cylindrical design of the sealing section means that a particularly low-injury design can be achieved, wherein the manufacturing costs are also particularly low. However, if the sealing section has a polygonal design, this makes it particularly easy to install, especially by using the angular design as a tool contact surface.

Advantageously, the mounting section and/or the sealing section each form a distal end of the base body in the longitudinal direction. In other words, a distal end or both distal ends, in particular the opposite distal ends, of the base body can be formed in the longitudinal direction by the mounting section or by the sealing section. In this way, a particularly simple assembly and/or a particularly advantageous outflow of a fluid to be vented, in particular compressed air, can be achieved.

Expediently, the sealing ring and/or the sealing rings is and/or are an O-ring. In other words, the sealing rings can be O-rings. This allows a particularly simple and cost-effective design to be achieved.

Advantageously, the ratio of the inner diameter of the sealing ring to the diameter of the fluid channel is in a range from 0.05 to 1.5, preferably in a range from 0.2 to 1, and particularly preferably in a range from 0.3 to 0.5. Alternatively, preferably, the ratio can also be in the ranges 0.05 to 0.95 or 0.5 to 0.8 or 0.6 to 0.7. The inner diameter of the sealing ring is in particular the diameter of a cylinder or a ball which can still just pass through the sealing ring, in particular without deforming the sealing ring. The diameter of the fluid channel is in particular the maximum, the minimum or the diameter averaged over the length of the fluid channel in a sectional plane perpendicular to the longitudinal direction. Particularly good sound absorption can be achieved with a ratio in the range of 0.05 to 1.5. If, on the other hand, the ratio is in the range of 0.2 to 1, this makes it particularly easy to install the sealing rings. If, in addition, the ratio is in a range of 0.3 to 0.5, the applicant has surprisingly found that particularly simple and effective venting can be achieved in this range, especially since vibrations of the sealing rings during venting can be reduced or even prevented.

Advantageously, the sound-absorbing element is made of foam and/or contains foam components. By forming the sound-absorbing element with and/or at least partially with foam elements, a particularly lightweight and sound-absorbing design of the sound-absorbing element can be achieved. Advantageously, the foam material can be an open-pored foam material.

Advantageously, the sound-absorbing element is held within the fluid channel via a force-fit connection, in particular via a press connection. In other words, the sound-absorbing element can therefore be held in the fluid channel, for example by an interference fit between the sound-absorbing element and the fluid channel. Alternatively or additionally preferably, there can also be an interlocking connection between the sound-absorbing element and the fluid channel. Such a material connection can be achieved by bonding, for example. In this way, a particularly durable fixing or assembly of the sound-absorbing element can be achieved. The advantage of a non-positive connection, in particular a clamp connection, on the other hand, lies in the ease with which the sound-absorbing element can be removed or replaced.

Expediently, the sound-absorbing element has a hollow central area, wherein the central area is fluidically connected to the fluid channel in particular via an opening in the sound-absorbing element. In other words, the sound-absorbing element can in particular have a center of gravity, which is arranged in a hollow area of the same. The central area is in particular an area located in the middle of the sound-absorbing element. In order to establish a fluidic connection between this central area and the fluid channel, in particular the opening of the fluid channel, the sound-absorbing element itself can have an opening in the central area. This allows a particularly low-flow-resistance connection to be achieved.

Advantageously, the sound-absorbing element is arranged in such a way that a fluid flow from the fluid channel into the groove or grooves must pass through the sound-absorbing element. In other words, the sound-absorbing element can be arranged in the fluid channel in such a way that any flow that enters the grooves from the fluid channel must pass through the sound-absorbing element. This arrangement is particularly advantageous with regard to sound absorption, as any fluid passing through the sound-absorbing element is positive with regard to pressure surges or noise development.

In a preferred embodiment, the hollow central area of the sound element is bounded by a wall in the longitudinal direction, in particular opposite the opening of the central area in the longitudinal direction. In particular, this wall can also be made of a foam material. In this way, a particularly advantageous and secure distal stop option of the sound-absorbing element can be achieved, so that assembly can be simplified as a result.

The sound-absorbing element is expediently designed as a single piece. The one-piece design of the sound-absorbing element not only makes it easy to install, but also means that the sound-absorbing element can withstand particularly high mechanical loads.

Advantageously, the venting system has a cover element, in particular a cover hood, wherein the cover element covers the sealing ring or rings arranged in the sealing section, in particular radially. In other words, this can mean that when the cover hood is projected onto the longitudinal direction, this projection encloses the projection of the sealing rings onto the longitudinal direction. Therefore, radial protection of the sealing rings or the sealing ring can be achieved by the cover hood or the cover element. In particular, the cover element is made of plastic and/or metal. The advantage of a metal is in particular its mechanical strength. The advantage of a plastic, on the other hand, lies in its corrosion resistance and/or its low cost.

In a preferred embodiment, the cover element is fixed, in particular reversibly, to the base body, in particular by means of a thread, and/or wherein a flow outlet, in particular a flow outlet formed in an annular shape around the longitudinal direction, is formed between the cover element and the base body. The reversible fixing of the cover element to the base body enables the cover element to be removed quickly and easily. In particular, this makes it easy to replace or maintain the venting system or its sealing rings. The reversible fixing can be carried out in a cost-effective and mechanically resilient manner via a thread. In particular, this thread can be a right-hand thread, which facilitates installation. Advantageously, the thread extends in or parallel to the longitudinal direction in order to achieve a simple mounting option. Alternatively or additionally preferably, the thread or the longitudinal direction extends perpendicular to a longitudinal axis of the vehicle and/or parallel to a width direction of a vehicle, in particular a commercial vehicle, when the vent is attached to the vehicle. It is particularly expedient if the thread is formed in one piece with the base body and/or borders the base body in the longitudinal direction or forms a distal end in the longitudinal direction of the base body. This can further simplify assembly. As an alternative to a thread, reversible fastening can also be achieved using a plug-in connection.

Preferably, the sealing section extends transversely to the mounting section. The term transverse means that the angle between the directions of extension or the main directions of extension of the mounting section and the sealing section enclose a smaller angle with each other, which is between 70° and 90°, preferably between 80° and 90° and particularly preferably between 85° and 90° and is most preferably 90°. This allows a particularly compact design to be achieved.

The sealing section expediently has two legs, wherein the legs extend in particular transversely, advantageously perpendicularly, to the mounting section, wherein each of the legs has at least one groove with a sealing ring. This allows a particularly good venting option to be created, which is also very compact in the longitudinal direction and can nevertheless vent a large amount of fluid. Such a design can therefore be very positive, especially when used in a commercial vehicle and/or when mounted on a hubcap. The legs advantageously each form or surround a part of the fluid channel. The legs can each have a groove or a plurality of grooves, which are or can be brought into fluid connection with the fluid channel, in particular via breakthroughs.

A further aspect of the invention may relate to a hubcap, wherein the hubcap comprises a venting system as described above and below. In other words, the invention may also relate to a hubcap system comprising a hubcap and a venting system as described above and below. In particular, the base body can be fixed to the main body of the hubcap by means of a material connection. It is particularly expedient if the hubcap or the main body of the hubcap is formed in one piece with the main body. In other words, the base body can be connected to the main body of the hubcap via a material-locking connection of the mounting section or a one-piece formation of the base body with the hubcap or its main body. This can result in a particularly mechanically resilient design. The longitudinal direction is expediently the direction about which the hubcap rotates in a subsequent mounting situation. In other words, the longitudinal direction can also be the direction about which the wheel on which the hubcap is to be mounted rotates. Alternatively, the longitudinal direction can also be arranged at a distance from the axis of rotation or the central axis of the hubcap, in particular in the radial direction. This can create a particularly simple mounting option. As an alternative to a material joint, the venting system can also be reversibly mounted on the base body, in particular via the mounting thread/thread of the mounting section.

A further aspect of the invention may relate to a use of a hubcap as described above and below or a venting system as described above or below in a commercial vehicle, in particular for sound-absorbed venting. In other words, the invention may relate to the use of a venting system or hubcap as described above and below in a commercial vehicle. Alternatively or additionally preferably, the invention may also relate to a use of a hubcap or a deflation system in a tire inflation system, in particular of a commercial vehicle. Alternatively or additionally preferably, the venting system can also be used in a rail vehicle.

### BRIEF DESCRIPTION OF THE DRAWINGS

Further advantages and features of the present invention are shown in the following description with reference to the figures. Individual features of the embodiments shown can also be used in other embodiments, unless this has been expressly excluded. The figures show

FIG. 1 is a section through a venting system;

FIG. 2 is an external view of a base body with a sealing section with a polygonal section;

FIG. 3 is a venting system with a cover element; and

FIG. 4 is a venting system with a sealing section perpendicular to the longitudinal direction.

### DETAILED DESCRIPTION

FIG. 1 shows a venting system 1. The venting system 1 has a base body 10 and three sealing rings 100. However, the venting system can also have more than three sealing rings, in particular four, five, six or seven sealing rings 100. Alternatively, the venting system can also preferably have only two or only one sealing ring 100. The sealing rings 100 are O-rings which are reversibly interchangeable. However, this reversible interchangeability of the sealing rings 100 with one another is the subject of the invention, in particular irrespective of the embodiment. Reversible interchangeability means in particular that the sealing rings 100 are identical in construction and/or can be interchanged without modification. In addition to the sealing rings 100, the venting system 1 also has a base body 10, which has a mounting section 20 and a sealing section 40. The fluid channel 60 is formed centrally within the base body 10, wherein the fluid channel 60 has a constant diameter along its extension in the longitudinal direction L. The sound-absorbing element 80, which has a hollow central area 82, is arranged within the fluid channel 60. This is in fluid connection with the fluid channel 60 via the opening 84 of the sound-absorbing element 80. In order to achieve a fluid flow from the fluid channel 60 through the sound-absorbing element 80, breakthroughs 44 are provided which each end in grooves 42. The grooves 42 are therefore in fluid connection with the fluid channel 60 through these breakthroughs 44. Furthermore, FIG. 1 shows an embodiment in which the sound-absorbing element 80 is arranged in such a way that a fluid flow from the fluid channel 60 into the grooves 42 must pass through the sound-absorbing element 80. In order to achieve mounting of the base body 10, the mounting section 20 has a thread 22. In the embodiment shown, the thread 22 and/or the mounting section 20 form a distal end in the longitudinal direction L of the base body 10. Distally opposite in the longitudinal direction L, the sealing section 40 forms the distal end of the base body 10 in the longitudinal direction L. The radial direction R is perpendicular to the longitudinal direction L.

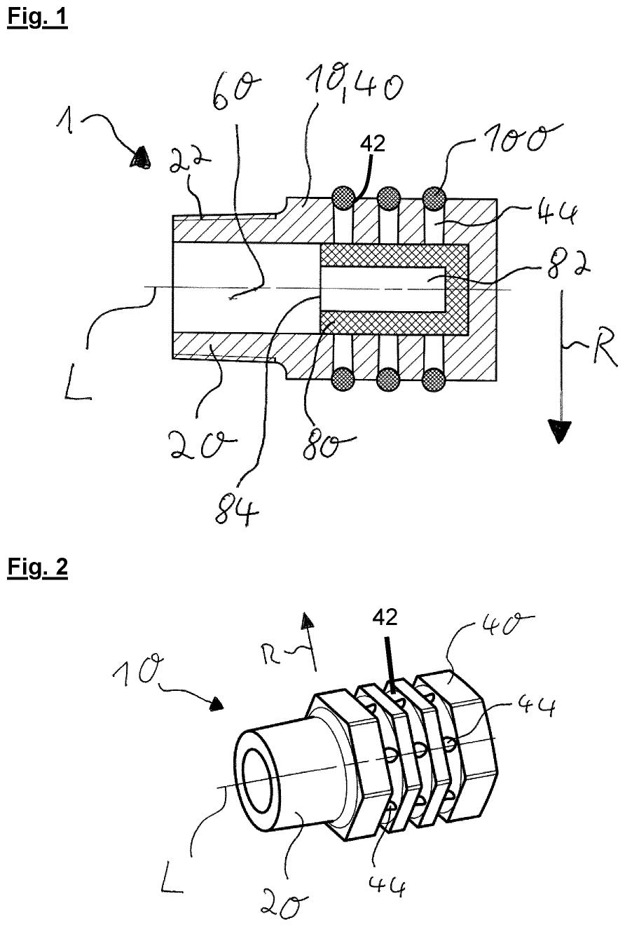

FIG. 2 shows a base body 10 for a venting system 1. The base body 10 has a polygonal section in its sealing section 40, wherein the grooves 42 are provided in this section. The grooves 42 are formed in the direction of the radial direction R. In the illustrated embodiment example, the polygonal section is a hexagonal section. The mounting section 20 has an unrecognizable internal thread for reversible mounting of the base body 10, in particular on a main body of a hubcap.

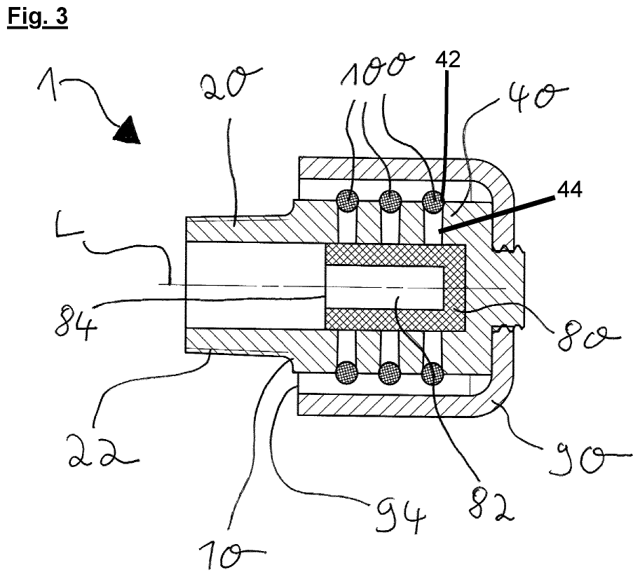

FIG. 3 shows an embodiment of a venting system 1, wherein the venting system 1 has a cover element 90 in the form of a cover hood in addition to the base body 10 and the sealing rings 100. The cover element 90 can basically be brought into contact with an end face, in particular an end face in the longitudinal direction L, of the base body 10, as can also be seen in FIG. 3. In the embodiment example shown, the base body 10 has a male thread, which is brought into a force-fit connection via an internal thread of the cover element 90 in order to secure the cover element 90 to the base body 10. Both the male and female threads extend in the longitudinal direction L and are formed around the longitudinal direction L. A flow outlet 94 is formed between the cover element 90 and the base body 10, through which the grooves 42 or the breakthroughs 44 and the fluid channel 60 are or can be brought into fluid connection with the environment.

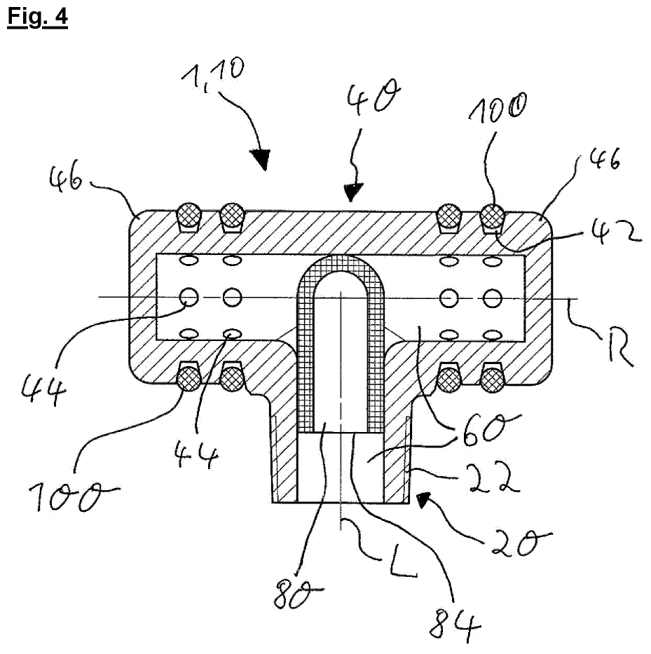

FIG. 4 shows an embodiment of a venting system 1, wherein the venting system 1 has a mounting section 20 and a sealing section 40 in addition to the base body 10 and the sealing rings 100. The fluid channel 60 is formed centrally within the base body 10. The mounting section 20 extends in the longitudinal direction L and the sealing section 40 with its two legs 46 in the radial direction R. The legs 46 are connected to the mounting section 20 by a material bond. The sound-absorbing element 80 is arranged within the fluid channel 60 in such a way that a fluid flow from the fluid channel 60 into the grooves 42 must pass through the sound-absorbing element 80. In order to achieve mounting of the base body 10, the mounting section 20 has a thread 22. In the embodiment shown, the thread 22 and/or the mounting section 20 form a distal end in the longitudinal direction L of the base body 10. Distally opposite in the longitudinal direction L, the sealing section 40 forms the distal end of the base body 10 in the longitudinal direction L. The legs 46 of the sealing section 40 each have two grooves 42, which are fluidically connected to the fluid channel 60 via breakthroughs 44. The sealing rings 100 are arranged within each of the grooves 42. The grooves 42 have V-shaped side walls.

### LIST OF REFERENCE SIGNS

1—Venting system
10—Base body
20—Mounting section
22—Thread in the mounting section (20)
40—Sealing section
42—Groove
44—Breakthrough
46—Leg
60—Fluid channel
80—Sound-absorbing element
82—Central area
84—Opening
90—Cover element
94—Flow outlet
100—Sealing ring
L—Longitudinal direction
R—Radial direction

1-10. (canceled)

11. A venting system, comprising:
a base body having a mounting section and a sealing section, wherein the base body and/or the mounting section and/or the sealing section extend in a longitudinal direction, and wherein the base body has a fluid channel which extends from the mounting section into the sealing section; and
at least one sealing ring held in at least circumferential groove in the sealing section, wherein the at least one groove is configured to be brought into fluid connection with the fluid channel via breakthroughs, and wherein a sound-absorbing element is arranged within the fluid channel.

12. The venting system according to claim 11, wherein the at least one sealing ring includes a plurality of sealing rings and the at last one groove includes a plurality of grooves.

13. The venting system according to claim 11, wherein the at least one groove includes a rounded side wall or a rounded groove base.

14. The venting system according to claim 11, wherein the mounting section has a thread arranged around and/or along the longitudinal direction.

15. The venting system according to claim 14, wherein the thread includes a self-sealing thread.

16. The venting system according to claim 11, wherein the sealing section has an outer cylindrical or polygonal section, and wherein the at least one groove is provided in this section in the direction of a radial direction and/or in the longitudinal direction.

17. The venting system according to claim 16, wherein the sound-absorbing element comprises a foam material.

18. The venting system according to claim 11, wherein the sound-absorbing element has a hollow central area, and wherein the central area is fluidically connected to the fluid channel via an opening of the sound-absorbing element.

19. The venting system according to claim 11, wherein the venting system has a cover element that covers the at least one sealing ring arranged in the sealing section.

20. The venting system according to claim 19, wherein the cover element includes a cover hood.

21. The venting system according to claim 19, wherein the at least one sealing ring is radially arranged in the sealing section.

22. The venting system according to claim 19, wherein the cover element is fixed to the base body.

23. The venting system according to claim 22, wherein the cover element is reversibly fixed to the base body.

24. The venting system according to claim 22, wherein the cover element is fixed to

25. The venting system according to claim 24, wherein a flow outlet is formed between the cover element and the base body.

26. The venting system according to claim 25, wherein the flow outlet is annular around the longitudinal direction.

27. A hubcap comprising a venting system according to claim 11.

28. A method of venting a commercial vehicle tire comprising providing the hubcap according to claim 27, and sound-absorbing venting the commercial vehicle tire via the hubcap.

29. A method of venting a commercial vehicle tire comprising providing the venting system according to claim 11, and sound-absorbing the commercial vehicle tire via the venting system.
